(19) United States
(12) Patent Application Publication
(10) Pub. No.: US 2025/0091836 A1
(43) Pub. Date: Mar. 20, 2025

(54) SYSTEM AND METHOD OF PROVIDING PIT ACCESS PROTECTION

(71) Applicant: OTIS ELEVATOR COMPANY, Farmington, CT (US)

(72) Inventors: Yingxin Gao, Farmington, CT (US); Paul Stranieri, Bristol, CT (US); Dennis Manning, Coventry, CT (US); Antonio Martins, Vernon, CT (US); James Chmiel, Suffield, CT (US); Leslie Watterson, Unionville, CT (US)

(21) Appl. No.: 18/468,383

(22) Filed: Sep. 15, 2023

(51) Int. Cl. B66B 5/02; B66B 1/32; B66B 1/34; B66B 5/00

(52) U.S. Cl. CPC B66B 5/021; B66B 1/32; B66B 1/3453; B66B 1/3492; B66B 5/0018

(57) ABSTRACT

An elevator system having a hoistway having a bottom landing with landing doors. An elevator car is in the hoistway, and a safety chain is coupled to the car and is in an open-state to stop the car and otherwise in an intact-state. A first sensor wirelessly transmits a first signal when the car is at the bottom landing, and a second sensor transmits a second signal when the doors are open. The system includes a control circuit including a first control element that receives the first signal indicating the car is at the bottom landing and a second control element that receives the second signal indicating the landing doors are open, and the control circuit changes state upon receipt of the signals, and the safety chain transitions to the open-state from the intact state when the control circuit changes state.

### BACKGROUND

The embodiments described herein are directed to elevator pit access and more specifically to a system and method of providing pit access protection.

Sensing implements for pit access protection may be connected via wired connections to control the safety chain. The wired connections may require extensive installation efforts of costly lengths of wire.

### BRIEF SUMMARY

Disclosed is an elevator system, including: a hoistway having a bottom landing with landing doors; an elevator car configured to move along the hoistway; a safety chain operationally coupled to the elevator car, wherein the safety chain is configured for being in an open-state to stop the elevator car and otherwise being in an intact-state; a first sensor mounted to the elevator car or the hoistway and configured to wirelessly transmit a first signal when the elevator car is at the bottom landing; a second sensor operationally coupled to the landing doors, the second sensor being configured to transmit a second signal when the landing doors are open; a printed circuit board (PCB) and a logic control circuit mounted to the PCB and configured to receive the first and second signals, wherein the logic control circuit includes a first control element configured to receive the first signal indicating the elevator car is at the bottom landing, a second control element configured to receive the second signal indicating the landing doors are open, and wherein the logic control circuit is configured to change state upon receipt of the first and second signals, and wherein the safety chain transitions to the open-state from the intact state when the logic control circuit changes state.

In addition to one or more aspects of the system or as an alternate the first sensor communicates with the logic control circuit via transmission of near field communication signal, optical signals or electromagnetic signals.

In addition to one or more aspects of the system or as an alternate the first sensor communicates with the logic control circuit via Bluetooth.

In addition to one or more aspects of the system or as an alternate the first control element is a magnetic latching relay.

In addition to one or more aspects of the system or as an alternate the second sensor is connected to the logic control circuit via a wired connection.

In addition to one or more aspects of the system or as an alternate the system includes a reset switch that is mounted within the system and configured to transmit a reset signal to the logic control circuit that resets the logic control circuit when the landing doors are closed.

In addition to one or more aspects of the system or as an alternate the reset switch and the logic control circuit have a wireless connection with each other.

In addition to one or more aspects of the system or as an alternate the reset switch communicates with the logic control circuit via Bluetooth.

In addition to one or more aspects of the system or as an alternate the system includes a power supply operationally coupled to the logic control circuit.

In addition to one or more aspects of the system or as an alternate the control circuit is configured to latch to maintain its state upon a power outage.

Further disclosed is a method of operating an elevator system, wherein: the system includes: a hoistway having a bottom landing with landing doors; an elevator car configured to move along the hoistway; a safety chain operationally coupled to the elevator car, wherein the safety chain is configured for being in an first-state to stop the elevator car and otherwise being in an second-state; a first sensor mounted to the elevator car or the hoistway and configured to wirelessly transmit a first signal when the elevator car is at the bottom landing; a second sensor operationally coupled to the landing doors, the second sensor being configured to transmit a second signal when the landing doors are open; a printed circuit board (PCB) and a logic control circuit mounted to the PCB and configured to receive the first and second signals, the method including: a first control element of the logic control circuit receiving the first signal when the elevator car is at the bottom landing; a second control element of the logic control circuit receiving the second signal indicates the landing doors are open; the logic control circuit changing state upon receiving the first and second signals; and the safety chain transitioning to an open-state from an intact state upon the logic control circuit changing state.

In addition to one or more aspects of the method or as an alternate the first sensor communicates with the logic control circuit via transmission of near field communication signal, optical signals or electromagnetic signals.

In addition to one or more aspects of the method or as an alternate the first sensor communicates with the logic control circuit via Bluetooth.

In addition to one or more aspects of the method or as an alternate the first control element is a magnetic latching relay.

In addition to one or more aspects of the method or as an alternate the second sensor is connected to the logic control circuit via a wired connection.

In addition to one or more aspects of the method or as an alternate the method includes a reset switch, mounted within the system, transmitting a reset signal to the logic control circuit that resets the logic control circuit when the landing doors are closed.

In addition to one or more aspects of the method or as an alternate the reset switch and the logic control circuit have a wireless connection with each other.

In addition to one or more aspects of the method or as an alternate the reset switch communicates with the logic control circuit via Bluetooth.

In addition to one or more aspects of the method or as an alternate a power supply is operationally coupled to the logic control circuit.

In addition to one or more aspects of the method or as an alternate the control circuit is configured to latch to maintain its state upon a power outage.

### BRIEF DESCRIPTION OF THE DRAWINGS

The present disclosure is illustrated by way of example and not limited in the accompanying figures in which like reference numerals indicate similar elements.

FIG. 1 is a schematic illustration of an elevator system that may employ various embodiments of the present disclosure;

FIG. 2 is a schematic illustration of an elevator system with sensors and control elements configured to provide pit access protection, according to an embodiment; and

FIG. 3 is a flowchart showing a method of operating an elevator system to provide pit access protection, according to an embodiment.

### DETAILED DESCRIPTION

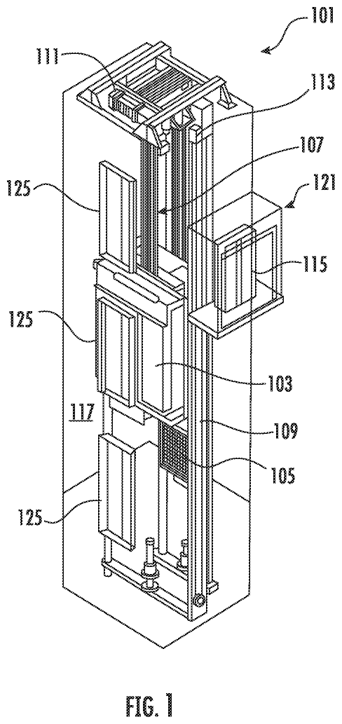

FIG. 1 is a perspective view of an elevator system 101 including an elevator car 103, a counterweight 105, a tension member 107, a guide rail (or rail system) 109, a machine (or machine system) 111, a position reference system 113, and an electronic elevator controller (controller) 115. The elevator car 103 and counterweight 105 are connected to each other by the tension member 107. The tension member 107 may include or be configured as, for example, ropes, steel cables, and/or coated-steel belts. The counterweight 105 is configured to balance a load of the elevator car 103 and is configured to facilitate movement of the elevator car 103 concurrently and in an opposite direction with respect to the counterweight 105 within an elevator shaft (or hoistway) 117 and along the guide rail 109.

The tension member 107 engages the machine 111, which is part of an overhead structure of the elevator system 101. The machine 111 is configured to control movement between the elevator car 103 and the counterweight 105. The position reference system 113 may be mounted on a fixed part at the top of the elevator shaft 117, such as on a support or guide rail, and may be configured to provide position signals related to a position of the elevator car 103 within the elevator shaft 117. In other embodiments, the position reference system 113 may be directly mounted to a moving component of the machine 111, or may be located in other positions and/or configurations as known in the art. The position reference system 113 can be any device or mechanism for monitoring a position of an elevator car and/or counter weight, as known in the art. For example, without limitation, the position reference system 113 can be an encoder, sensor, or other system and can include velocity sensing, absolute position sensing, etc., as will be appreciated by those of skill in the art.

The controller 115 may be located in a controller room 121 of the elevator shaft 117. It is to be appreciated that the controller 115 need not be in the controller room 121 but may be in the hoistway or other location in the elevator system. According to an aspect, the controller 115 is configured to control the operation of the elevator system 101, and particularly the elevator car 103. For example, the controller 115 may provide drive signals to the machine 111 to control the acceleration, deceleration, leveling, stopping, etc. of the elevator car 103. The controller 115 may also be configured to receive position signals from the position reference system 113 or any other desired position reference device. When moving up or down within the elevator shaft 117 along guide rail 109, the elevator car 103 may stop at one or more landings 125 as controlled by the controller 115. Although shown in an controller room 121, those of skill in the art will appreciate that the controller 115 can be located and/or configured in other locations or positions within the elevator system 101. In one embodiment, the controller may be located remotely or in the cloud.

The machine 111 may include a motor or similar driving mechanism. In accordance with embodiments of the disclosure, the machine 111 is configured to include an electrically driven motor. The power supply for the motor may be any power source, including a power grid, which, in combination with other components, is supplied to the motor. The machine 111 may include a traction sheave that imparts force to tension member 107 to move the elevator car 103 within elevator shaft 117.

Although shown and described with a roping system including tension member 107, elevator systems that employ other methods and mechanisms of moving an elevator car within an elevator shaft may employ embodiments of the present disclosure. For example, embodiments may be employed in ropeless elevator systems using a linear motor to impart motion to an elevator car. Embodiments may also be employed in ropeless elevator systems using a hydraulic lift to impart motion to an elevator car. Embodiments may also be employed in ropeless elevator systems using self-propelled elevator cars (e.g., elevator cars equipped with friction wheels, pinch wheels or traction wheels). FIG. 1 is merely a non-limiting example presented for illustrative and explanatory purposes.

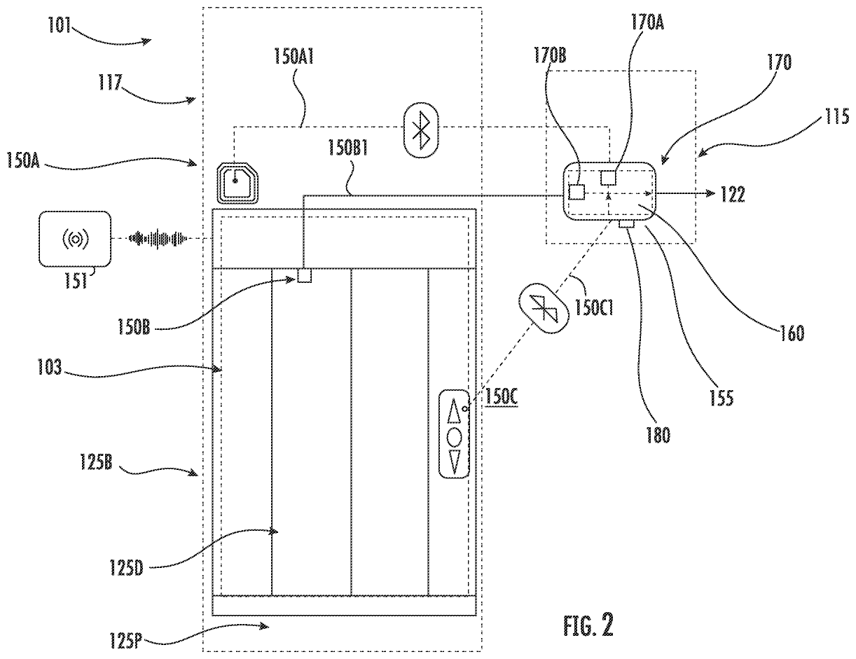

Turning to FIG. 2, the elevator system 101 includes the hoistway 117 having a bottom landing 125B above a pit 125P. The bottom landing 125B has landing doors 125D. The elevator car 103, shown schematically is configured to move along the hoistway 117. A safety chain 122 is operationally coupled to the elevator car 103. The safety chain 122 is configured for being in a first-state, e.g., open, to stop the elevator car 103 and otherwise being in an second-state, e.g., intact, which allows the car 103 to run.

A first sensor 150A is an elevator position sensor mounted to the elevator car 103 or in the hoistway and configured to wirelessly transmit a first signal 150A1 indicative of whether the elevator car 103 is at the bottom landing 125B. In one embodiment, the first sensor 150A senses the elevator car 103 is located at the bottom landing 125B by communicating with a tag 151 in the hoistway 117 at the bottom landing 125B. The tag 151 may utilize a near field communication protocols. A second sensor 150B, which may be a landing door interlock, e.g., an electrical contact, is operationally coupled to the landing doors 125D. The second sensor 150B is configured to transmit a second signal 150B1 indicative of whether the landing doors 125D are open. It is to be appreciated that optical or electromagnetic technologies can be used for the sensors as non-limiting examples.

An enclosure 155 is located in the pit 125P, the hoistway 117, the control room 115, or mounted to other convenient location within the system 101. A printed circuit board (PCB) 160 is within the enclosure 155 and a logic control circuit 170 is mounted to the PCB 160 and is configured to receive the first and second signals 150A1, 150B1.

The logic control circuit 170 includes a first control element 170A that is configured to receive the first signal 150A1 when the elevator car 103 is at the bottom landing 125B. A second control element 170B is configured to receive the second signal 150B1 when the landing doors 125 are open. The logic control circuit 170 is configured to change state based on signals from the first and second control elements 170A, 170B. Thus causes the safety chain 122 to change state from intact to open.

The first sensor 150A communicates with the logic control circuit 170 via transmission of near field communication signal, optical signals or electromagnetic signals. In one embodiment the first sensor 150A communicates with the logic control circuit 170 via Bluetooth. The first control element 170A may be a magnetic latching relay in one embodiment. In one embodiment the second control element 170B is a dual armature relay, which may be a compact and low power component. In one embodiment the second sensor 150B is connected to the logic control circuit 170 via a wired connection.

A reset switch 150C is located at the bottom landing 125B and configured to transmit a reset signal 150C1 to the logic control circuit 170 when the landing doors 125D are closed. This causes the logic control circuit 170 to change state, and the safety chain 122 then changes to the intact state from the open state.

In one embodiment the reset switch 150C and the logic control circuit 170 have a wireless connection with each other. In one embodiment the reset switch 150C communicates with the logic control circuit 170 via Bluetooth. A power supply 180, providing, e.g., 24VDC, is operationally coupled to the logic control circuit 170. The logic control circuit 170, using magnetic latching relays, is configured to latch to maintain its state through a power outage.

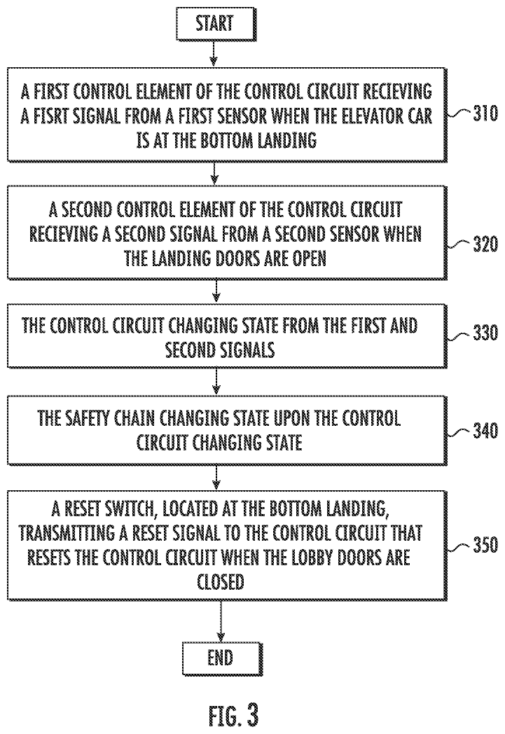

Turning to FIG. 3, a flowchart shows a method of operating the elevator system 101 to provide pit access protection. As shown in block 310, the method includes the first control element 170A of the logic control circuit 170 receiving the first signal 150A1 from the first sensor 150A when the elevator car 103 is at the bottom landing 125B. As shown in block 320, the method includes the second control element 170B of the logic control circuit 170 receiving the second signal 150B1 from the second sensor 150B when the landing doors 125D are open. As shown in block 330, the method includes the control circuit 170 changing state from the first and second signals. As shown in block 340, the method includes the safety chain 122 changing state, e.g., to open from intact, upon the control circuit 170 changing state. As shown in block 350, the method includes a reset switch 150C, located at the bottom landing 125B (or otherwise mounted within the system 101), transmitting a reset signal 150C1 to the logic control circuit 170 that resets the logic control circuit 170 when the landing doors 125D are closed. The safety chain then changes state again, from open to intact. Thus, embodiments disclosed herein provide a system with pit access protection. The system includes an elevator position sensor 150A that is installed in the hoistway 117 to detect the car position. A reset switch 150C is installed outside the hoistway 117 to reset the logic control circuit 170 and allow the car 103 to travel. An enclosure 155 mounted within the system 101 includes the logic control circuit 170 and connects to the safety chain 122. Wireless communications between the sensors and control elements of the control circuit reduce the installation cost compared with, e.g., wired connections.

Sensor data identified herein may be obtained and processed separately, or simultaneously and stitched together, or a combination thereof, and may be processed in a raw or complied form. The sensor data may be processed on the sensor (e.g. via edge computing), by controllers identified or implicated herein, on a cloud service, or by a combination of one or more of these computing systems. The sensor may communicate the data via wired or wireless transmission lines, applying one or more protocols as indicated below.

Wireless connections may apply protocols that include local area network (LAN, or WLAN for wireless LAN) protocols. LAN protocols include WiFi technology, based on the Section 802.11 standards from the Institute of Electrical and Electronics Engineers (IEEE). Other applicable protocols include Low Power WAN (LPWAN), which is a wireless wide area network (WAN) designed to allow long-range communications at a low bit rates, to enable end devices to operate for extended periods of time (years) using battery power. Long Range WAN (LoRaWAN) is one type of LPWAN maintained by the LoRa Alliance, and is a media access control (MAC) layer protocol for transferring management and application messages between a network server and application server, respectively. LAN and WAN protocols may be generally considered TCP/IP protocols (transmission control protocol/Internet protocol), used to govern the connection of computer systems to the Internet. Wireless connections may also apply protocols that include private area network (PAN) protocols. PAN protocols include, for example, Bluetooth Low Energy (BTLE), which is a wireless technology standard designed and marketed by the Bluetooth Special Interest Group (SIG) for exchanging data over short distances using short-wavelength radio waves. PAN protocols also include Zigbee, a technology based on Section 802.15.4 protocols from the IEEE, representing a suite of high-level communication protocols used to create personal area networks with small, low-power digital radios for low-power low-bandwidth needs. Such protocols also include Z-Wave, which is a wireless communications protocol supported by the Z-Wave Alliance that uses a mesh network, applying low-energy radio waves to communicate between devices such as appliances, allowing for wireless control of the same.

Wireless connections may also include radio-frequency identification (RFID) technology, used for communicating with an integrated chip (IC), e.g., on an RFID smartcard. In addition, Sub-1Ghz RF equipment operates in the ISM (industrial, scientific and medical) spectrum bands below Sub 1 Ghz-typically in the 769-935 MHz, 315 Mhz and the 468 Mhz frequency range. This spectrum band below 1 Ghz is particularly useful for RF IOT (internet of things) applications. The Internet of things (IoT) describes the network of physical objects—“things”—that are embedded with sensors, software, and other technologies for the purpose of connecting and exchanging data with other devices and systems over the Internet. Other LPWAN-IOT technologies include narrowband internet of things (NB-IOT) and Category M1 internet of things (Cat M1-IOT). Wireless communications for the disclosed systems may include cellular, e.g. 2G/3G/4G (etc.). Other wireless platforms based on RFID technologies include Near-Field-Communication (NFC), which is a set of communication protocols for low-speed communications, e.g., to exchange date between electronic devices over a short distance. NFC standards are defined by the ISO/IEC (defined below), the NFC Forum and the GSMA (Global System for Mobile Communications) group. The above is not intended on limiting the scope of applicable wireless technologies.

Wired connections may include connections (cables/interfaces) under RS (recommended standard)-422, also known as the TIA/EIA-422, which is a technical standard supported by the Telecommunications Industry Association (TIA) and which originated by the Electronic Industries Alliance (EIA) that specifies electrical characteristics of a digital signaling circuit. Wired connections may also include (cables/interfaces) under the RS-232 standard for serial communication transmission of data, which formally defines signals connecting between a DTE (data terminal equipment) such as a computer terminal, and a DCE (data circuit-terminating equipment or data communication equipment), such as a modem. Wired connections may also include connections (cables/interfaces) under the Modbus serial communications protocol, managed by the Modbus Organization. Modbus is a master/slave protocol designed for use with its programmable logic controllers (PLCs) and which is commonly a available means of connecting industrial electronic devices. Wireless connections may also include connectors (cables/interfaces) under the PROFibus (Process Field Bus) standard managed by PROFIBUS & PROFINET International (PI). PROFibus which is a standard for fieldbus communication in automation technology, openly published as part of IEC (International Electrotechnical Commission) 61158. Wired communications may also be over a Controller Area Network (CAN) bus. A CAN is a vehicle bus standard that allow microcontrollers and devices to communicate with each other in applications without a host computer. CAN is a message-based protocol released by the International Organization for Standards (ISO). The above is not intended on limiting the scope of applicable wired technologies.

When data is transmitted over a network between end processors as identified herein, the data may be transmitted in raw form or may be processed in whole or part at any one of the end processors or an intermediate processor, e.g., at a cloud service (e.g. where at least a portion of the transmission path is wireless) or other processor. The data may be parsed at any one of the processors, partially or completely processed or complied, and may then be stitched together or maintained as separate packets of information. Each processor or controller identified herein may be, but is not limited to, a single-processor or multi-processor system of any of a wide array of possible architectures, including field programmable gate array (FPGA), central processing unit (CPU), application specific integrated circuits (ASIC), digital signal processor (DSP) or graphics processing unit (GPU) hardware arranged homogenously or heterogeneously. The memory identified herein may be but is not limited to a random access memory (RAM), read only memory (ROM), or other electronic, optical, magnetic or any other computer readable medium.

The controller may further include, in addition to a processor and non-volatile memory, one or more input and/or output (I/O) device interface(s) that are communicatively coupled via an onboard (local) interface to communicate among other devices. The onboard interface may include, for example but not limited to, an onboard system bus, including a control bus (for inter-device communications), an address bus (for physical addressing) and a data bus (for transferring data). That is, the system bus may enable the electronic communications between the processor, memory and I/O connections. The I/O connections may also include wired connections and/or wireless connections identified herein. The onboard interface may have additional elements, which are omitted for simplicity, such as controllers, buffers (caches), drivers, repeaters, and receivers to enable electronic communications. The memory may execute programs, access data, or lookup charts, or a combination of each, in furtherance of its processing, all of which may be stored in advance or received during execution of its processes by other computing devices, e.g., via a cloud service or other network connection identified herein with other processors.

Embodiments can be in the form of processor-implemented processes and devices for practicing those processes, such as processor. Embodiments can also be in the form of computer code based modules, e.g., computer program code (e.g., computer program product) containing instructions embodied in tangible media (e.g., non-transitory computer readable medium), such as floppy diskettes, CD ROMs, hard drives, on processor registers as firmware, or any other non-transitory computer readable medium, wherein, when the computer program code is loaded into and executed by a computer, the computer becomes a device for practicing the embodiments. Embodiments can also be in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes a device for practicing the exemplary embodiments. When implemented on a general-purpose microprocessor, the computer program code segments configure the microprocessor to create specific logic circuits.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

Those of skill in the art will appreciate that various example embodiments are shown and described herein, each having certain features in the particular embodiments, but the present disclosure is not thus limited. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the appended claims.

What is claimed is:

1. An elevator system, comprising:
a hoistway having a bottom landing with landing doors;
an elevator car configured to move along the hoistway;
a safety chain operationally coupled to the elevator car, wherein the safety chain is configured for being in an open-state to stop the elevator car and otherwise being in an intact-state;
a first sensor mounted to the elevator car or the hoistway and configured to wirelessly transmit a first signal when the elevator car is at the bottom landing;
a second sensor operationally coupled to the landing doors, the second sensor being configured to transmit a second signal when the landing doors are open;
a printed circuit board (PCB); and
a logic control circuit mounted to the PCB and configured to receive the first and second signals,
wherein the logic control circuit includes a first control element configured to receive the first signal indicating the elevator car is at the bottom landing, a second control element configured to receive the second signal indicating the landing doors are open, and wherein the logic control circuit is configured to change state upon receipt of the first and second signals, and
wherein the safety chain transitions to the open-state from the intact state when the logic control circuit changes state.

2. The system of claim 1, wherein the first sensor communicates with the logic control circuit via transmission of near field communication signal, optical signals or electromagnetic signals.

3. The system of claim 2, wherein the first sensor communicates with the logic control circuit via Bluetooth.

4. The system of claim 1, wherein the first control element is a magnetic latching relay.

5. The system of claim 1, wherein the second sensor is connected to the logic control circuit via a wired connection.

6. The system of claim 1, comprising a reset switch that is mounted within the system and configured to transmit a reset signal to the logic control circuit that resets the logic control circuit when the landing doors are closed.

7. The system of claim 6, wherein the reset switch and the logic control circuit have a wireless connection with each other.

8. The system of claim 7, wherein the reset switch communicates with the logic control circuit via Bluetooth.

9. The system of claim 1, including a power supply operationally coupled to the logic control circuit.

10. The system of claim 9, wherein the control circuit is configured to latch to maintain its state upon a power outage.

11. A method of operating an elevator system, wherein:
the system includes: a hoistway having a bottom landing with landing doors; an elevator car configured to move along the hoistway; a safety chain operationally coupled to the elevator car, wherein the safety chain is configured for being in an first-state to stop the elevator car and otherwise being in an second-state; a first sensor mounted to the elevator car or the hoistway and configured to wirelessly transmit a first signal when the elevator car is at the bottom landing; a second sensor operationally coupled to the landing doors, the second sensor being configured to transmit a second signal when the landing doors are open; a printed circuit board (PCB) and a logic control circuit mounted to the PCB, the logic control circuit being configured to receive the first and second signals,
the method comprising:
a first control element of the logic control circuit receiving the first signal when the elevator car is at the bottom landing;
a second control element of the logic control circuit receiving the second signal indicates the landing doors are open;
the logic control circuit changing state upon receiving the first and second signals; and
the safety chain transitioning to an open-state from an intact state upon the logic control circuit changing state.

12. The method of claim 11, wherein the first sensor communicates with the logic control circuit via transmission of near field communication signal, optical signals or electromagnetic signals.

13. The method of claim 12, wherein the first sensor communicates with the logic control circuit via Bluetooth.

14. The method of claim 13, wherein the first control element is a magnetic latching relay.

15. The method of claim 11, wherein the second sensor is connected to the logic control circuit via a wired connection.

16. The method of claim 11, comprising a reset switch, mounted within the system, transmitting a reset signal to the logic control circuit that resets the logic control circuit when the landing doors are closed.

17. The method of claim 16, wherein the reset switch and the logic control circuit have a wireless connection with each other.

18. The method of claim 17, wherein the reset switch communicates with the logic control circuit via Bluetooth.

19. The method of claim 11, wherein a power supply is operationally coupled to the logic control circuit.

20. The method of claim 19, wherein the control circuit is configured to latch to maintain its state upon a power outage.
